(19) United States
(12) Patent Application Publication
(10) Pub. No.: US 2020/0314040 A1
(43) Pub. Date: Oct. 1, 2020

(54) TECHNOLOGY FOR COMMUNICATION BETWEEN DIFFERENT INSTANT MESSAGING PROTOCOLS AND SIP PROTOCOL

(71) Applicant: Ankang Hongtian Science&Techonology Incorporated Company, Ankang (CN)

(72) Inventor: Lihong HAO, Ankang (CN)

(21) Appl. No.: 16/392,971

(22) Filed: Apr. 24, 2019

(30) Foreign Application Priority Data
Mar. 26, 2019 (CN) 201910233593.9

(51) Int. Cl. H04L 12/58; H04L 29/06

(52) U.S. Cl. CPC H04L 51/04; H04L 69/08; H04L 65/1006; H04L 51/36

(57) ABSTRACT

The disclosure discloses a technology for communication between different instant messaging protocols and SIP protocol, the technology comprises a conversion method, a gateway and a device, wherein inputting first information using an instant messaging non-SIP standard protocol or second information using a SIP standard protocol; converting the first information using the instant messaging non-SIP standard protocol into the second information using the SIP standard protocol, or converting the second information using the SIP standard protocol into the first information using the instant messaging non-SIP standard protocol; outputting the second information using the SIP standard protocol or the first information using the instant messaging non-SIP standard protocol. By means of the method, the disclosure provides technical support for audio, video and information communication between instant messaging systems and communication systems of the SIP standard protocol.

### CROSS-REFERENCE TO RELATED APPLICATIONS

This application claims the benefit of priority from Chinese Patent Application No. CN201910233593.9, filed on Mar. 26, 2019. The content of the aforementioned application, including any intervening amendments thereto, is incorporated herein by reference in its entirety.

### TECHNICAL FIELD

The disclosure relates to communication technology, and in particular relates to a technology for communication between different instant messaging protocols and SIP protocol.

### BACKGROUND OF THE DISCLOSURE

At present, the internet Over The Top (OTT) communication protocols comprises two parts: messages (a text, a picture, a video, a file and the like) are realized through an instant messaging Extensible Messaging and Presence Protocol (XMPP), a Message Queuing Telemetry Transport Protocol (MQTT), a Socket Protocol or an enterprise private protocol; and audio and video communication is realized through H323, a Session Initiation Protocol (SIP) and an enterprise private protocol.

Instant messaging (IM) is an OTT application based on the internet. A enterprise private protocol or a industry protocol standard are adopted by a lot of IM enterprises on the basis of market positioning and differences of business emphasis; and other instant messaging systems respectively use the different technologies mentioned above. In conclusion, various systems cannot communicate with each other, such as communication between QQ and Wechat. In order to create an instant messaging unified standard, the Internet Engineering Task Force (IETF) is tried repeatedly, and nothing has been done successfully.

In a long-term research and development process, the inventor of the application finds that the most direct problem caused by the situations mentioned above is that the communication difficulty between all the systems is large, which leads to series of problems such as application fragmentation, inconvenience in use for users, potential safety hazards of information and the like.

### SUMMARY OF THE INVENTION

The technical problem mainly solved by the disclosure is to provide an method for converting information, a gateway and a device with a storage function, technical support can be provided for information communication among all the systems, so as further to avoid the problems of application fragmentation, to provide convenience in use for users, and to avoid potential safety hazards of information.

In order to solve the technical problem, a technical solution adopted by the disclosure is as follows: providing an method for converting information, and the method comprising: inputting first information using an instant messaging non-SIP or second information using a SIP; converting the first information using the instant messaging non-SIP standard protocol into the second information using the SIP standard protocol, or converting the second information using the SIP standard protocol into the first information using the instant messaging non-SIP standard protocol; outputting the second information using the SIP standard protocol or the first information using the instant messaging non-SIP standard protocol.

Wherein the first information is at least one of a text, a picture, a video and a file.

Wherein the second information only retains a text message part in the first information.

Wherein the second information is a message of a message standard SIPMES SAGE in the SIP standard protocol.

Wherein the non-SIP standard initial protocol comprises: at least one of an Extensible Messaging and Presence protocol (XMPP), a Message Queuing Telemetry Transport protocol (MQTT), a Socket protocol (Socket) and an enterprise private protocol.

Wherein the first information is at least one of an audio, an audio-and-video.

Wherein the second information is information of a RFC3261 standard in the SIP standard protocol.

Wherein the non-SIP standard protocol comprises: at least one of a H323 protocol and an enterprise private protocol.

In order to solve the technical problem, another technical solution adopted by the disclosure is as follows: the disclosure provides a gateway, the gateway includes: a processor, a memory and a communication circuit, the processor is respectively coupled with the memory and the communication circuit, when the processor, the memory and the communication circuit are in operation, the steps in a method of any one mentioned above are realized.

In order to solve the technical problem, another technical solution adopted by the disclosure is as follows: the disclosure provides a device with storage function, program data is stored on the device, when the program data is executed by the processor, the steps in a method of any one mentioned above are realized.

The disclosure has the beneficial effects that: comparing with the situations in the current technology, the disclosure is that inputting first information using an instant messaging non-SIP or second information using a SIP; converting the first information using the instant messaging non-SIP standard protocol into the second information using the SIP standard protocol, or converting the second information using the SIP standard protocol into the first information using the instant messaging non-SIP standard protocol; outputting the second information using the SIP standard protocol or the first information using the instant messaging non-SIP standard protocol. Due to the fact that the first information using the instant messaging non-SIP standard protocol is converted into the second information using the SIP standard protocol, or the second information using the SIP standard protocol is converted into the first information using the instant messaging non-SIP standard protocol, so that the first information using the instant messaging non-SIP standard protocol and the second information using the SIP standard protocol can be mutually converted, and the method provides technical support for information communication between an instant messaging system and a communication system of the SIP standard protocol, so that the application fragmentation can be avoided, the convenience in use is provided for the users, and the problems of potential safety hazards and the like are avoided.

### BRIEF OF THE DRAWINGS

In order to more clearly illustrate the technical solutions in the embodiments of the application, the accompanying drawings required to be used in the description of the embodiments are introduced briefly hereinafter, apparently the accompanying drawings in the following description are merely some embodiments of the application, and those skilled in the art should understand that on the premise of not paying any creative work, other drawings can also be obtained according to the accompanying drawings, wherein

FIG. 1 is a schematic diagram of independent communication between a plurality of instant messaging systems in the prior art;

FIG. 2 is a flow diagram of an method for converting information according to an embodiment of the disclosure;

FIG. 3 is a schematic structural diagram of a gateway according to an embodiment of the disclosure;

FIG. 4 is a schematic structural diagram of a device with a storage function according to an embodiment of the disclosure.

### DETAILED OF EMBODIMENTS

The technical solutions in the embodiments of the application will be clearly and completely described with reference to the accompanying drawings in the embodiments of the application. Apparently, the described embodiments are merely a part of the embodiments of the application rather than all embodiments. Based on the embodiments of the application, all other embodiments obtained by ordinary skilled in the art without creative efforts are belong to the protection scope of the application.

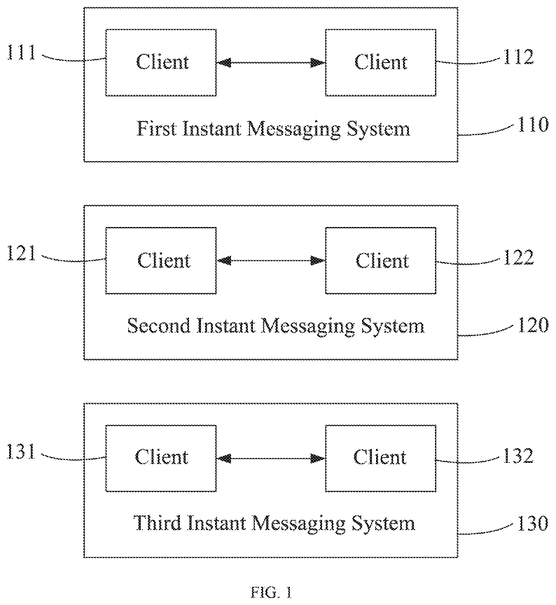

Referring to FIG. 1, FIG. 1 is a schematic diagram of independent communication between a plurality of instant messaging systems in the prior art. Due to the fact that a first instant messaging system, a second instant messaging system, a third instant messaging system and the like respectively use different communication protocols, a client of the first instant messaging system can only communicate with another client of the first instant messaging system, and a client of the second instant messaging system can only communicate with another client of the second instant messaging system, and a client of the third instant messaging system can only communicate with another client of the third instant messaging system, and the like. A client of the first instant messaging system cannot communicate with a client of the second instant messaging system, and also cannot communicate with a client of the third instant messaging system, and a client of the second instant messaging system cannot communicate with a client of the third instant messaging system, and the like.

For example, QQ and Wechat cannot send information to each other. A user A sends the information to a user B through QQ, in order to increase the probability that the user B receives the information, the user A sends the information to the user B through Wechat again, so that the instant messaging applications are not compatible with each other, and each of the instant messaging application is in a fragmentation state. For users, redundant operation needs to be carried out, and inconvenience is brought to the users; repeated transmission also increases the problems of information security risks and the like.

According to the disclosure, first information using an instant messaging non-SIP standard protocol is converted into second information using a SIP standard protocol, or a second information using a SIP standard protocol is converted into a first information using an instant messaging non-SIP standard protocol, so that the first information using the instant messaging non-SIP standard protocol and the second information using the SIP standard protocol can be mutually converted, and the disclosure provides technical support for information communication between the instant messaging systems and the communication systems of the SIP standard protocol, so that the application fragmentation can be avoided, the convenience in use is provided for the users, and the problems of potential safety hazards and the like are avoided.

The disclosure will be described in detail with reference to the accompanying drawings and the embodiments.

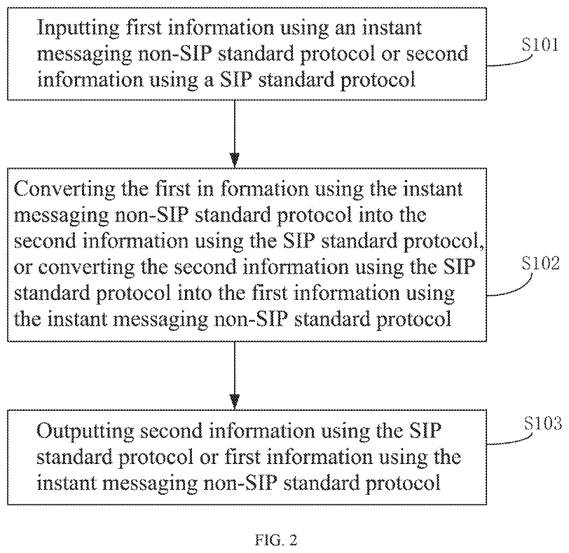

Referring to FIG. 2, FIG. 2 is a flow diagram of an method for converting information according to an embodiment of the disclosure, the method includes:

S101: inputting first information using an instant messaging non-SIP standard protocol or second information using a SIP standard protocol.

The Session Initiation Protocol (SIP) is a signaling protocol provided by the Internet Engineering Task Force (IETF), the purpose of SIP is to establish, modify and terminate application layer protocols of one or more multimedia sessions in the network of the Internet Protocol (IP). Main applications of SIP include, but is not limited to, voice, messaging, video, call control and the like. An important feature of SIP is that it does not define the type of session to be established, but only defines how to manage the conversation, so that the flexibility is achieved. It means that the SIP can be used in numerous applications and services, including interactive games, music, video-on-demand, voice, video and web conferences. The SIP messages are text-based, so the SIP messages are easy to read and debug.

The instant messaging non-SIP standard protocol refers to a communication protocol other than the instant messaging SIP standard protocol, including but not limited to: an Extensible Messaging and Presence protocol (XMPP), a Message Queuing Telemetry Transport protocol (MQTT), a Socket protocol (Socket) and an enterprise private protocol and an H323 protocol. Wherein XMPP, MQTT, Socket and enterprise private protocol are communication protocols often adopted by a text, a picture, a video, a file and the like. Enterprise private protocol and H323 protocol are communication protocols often adopted by audios and audios-and-videos.

The XMPP, also called Jabber, is an open real-time communication protocol based on an Extensible Markup Language (XML), and is an internet standard passed by the Internet Engineering Task Force (IETF). The XMPP is in contact with a large number of people due to the fact that Google Talk and NetEase bubble use it. However, the XMPP does not have binary data, and the file transmission protocol uses the external Hyper Text Transfer Protocol (HTTP).

MQTT is a message transmission protocol which is pushed by IBM corporation and is based on a publish/subscribe mode of a lightweight agent. MQTT operate on a Transmission Control Protocol (TCP) stack and is used for providing a guarantee for an orderly, reliable and bi-directional network connection. Due to the fact that the method is open, simple and easy to implement, the method can be applied to an environment with limited resources, and is a quite good option for application program of Machine to Machine (M2M) and the internet of things.

TCP uses the IP address of a host and the port number of the host as an endpoint of a TCP connection, and the endpoint is called the Socket. The socket is represented by (IP address: port number), which is an abstract representation of endpoints in a network communication process, and comprises five kinds of information necessary for network communication: a protocol used for connection, IP address of a local host, protocol port of a local process, IP address of a remote host and protocol port of a remote process.

Enterprise private protocol is a set of enterprise internal self-defined protocol standards, and is only suitable for equipment products produced by the enterprise. The purpose of making a private protocol by an enterprise is to achieve technical monopolization, so that a unique high profit is obtained, and an outstanding position in the field is achieved.

H323 protocol is a standard audio and video transmission protocol, is composed of a set of protocols, wherein some of the protocols are responsible for encoding, decoding and packaging of audio and video signals, and there is signaling which is responsible for transceiving and controlling of call signaling, and there is signaling which is responsible for capability exchange.

The XMPP, MQTT, Socket, enterprise private protocol, and H323 protocol is a communication protocol which is widely used for instant messaging in current technology, so that the range of the first information can be expanded in this way, and then the application range of the method can be expanded.

S102: converting the first information using the instant messaging non-SIP standard protocol into the second information using the SIP standard protocol, or converting the second information using the SIP standard protocol into the first information using the instant messaging non-SIP standard protocol.

If the first information is input, the first information adopts an instant messaging non-SIP standard protocol, then the first information is converted into second information, namely the instant messaging non-SIP standard protocol is converted into the SIP standard protocol. If the second information is input, the second information adopts the SIP standard protocol, and then the second information is converted into first information, namely the SIP standard protocol is converted into an instant messaging non-SIP standard protocol. By means of the method, the first information adopting the instant messaging non-SIP standard protocol converting into the second information adopting the SIP standard protocol can be achieved, and the method provides technical support for information communication between the instant messaging systems and the communication systems of the SIP standard protocol, so that the application fragmentation can be avoided, the convenience in use is provided for the users, and the problems of potential safety hazards and the like are avoided.

S103: outputting second information using the SIP standard protocol or first information using the instant messaging non-SIP standard protocol.

According to the embodiment of the disclosure, inputting a first information using the instant messaging non-SIP standard protocol or a second information using the SIP standard protocol; converting the first information using the instant messaging non-SIP standard protocol into second information using the SIP standard protocol, or converting the second information using the SIP standard protocol into the first information using the instant messaging non-SIP standard protocol; outputting the second information using the SIP standard protocol or the first information using the instant messaging non-SIP standard protocol. Due to the fact that the first information using the instant messaging non-SIP standard protocol is converted into second information using the SIP standard protocol, or the second information using the SIP standard protocol is converted into the first information using the instant messaging non-SIP standard protocol, so that the first information using the instant messaging non-SIP standard protocol and the second information using the SIP standard protocol can be mutually converted, and the method provides technical support for information communication between the instant messaging systems and the communication systems of the SIP standard protocol, so that the application fragmentation can be avoided, the convenience in use is provided for the users, and the problems of potential safety hazards and the like are avoided.

On the other hand, if the method is used in the instant of a non-SIP standard protocol. communication the system is in communication with a communication system of the SIP standard protocol, the original non-SIP standard protocol instant messaging system cannot be influenced, can still operate normally independently, and therefore, by means of the mode, and the communication between the instant messaging system of the non-SIP standard protocol and the communication system of the SIP standard protocol can be realized with the minimum cost.

On the other hand, if the method is used when an instant messaging system of non-SIP standard protocol communicates with a communication system of the SIP standard protocol, the original instant messaging system of non-SIP standard protocol may not be influenced, and can still operate normally independently. Therefore, by means of the mode, communication between an instant messaging system of the non-SIP standard protocol and a communication system of the SIP standard protocol can be realized with the minimum cost.

on the other hand, if the communication system of the SIP standard protocol is respectively connected with the instant messaging systems of the two different non-SIP standard protocols, information communication between the instant messaging systems of the two different non-SIP standard protocols can be achieved, so that technical support is provided for information communication among all the systems.

In one embodiment, the first information is at least one of a text, a picture, a video and a file. The text, the picture, the video and the file are frequently used data types in instant messaging.

Further, if the first information is at least one of a text, a picture, a video and a file, when the first information is converted into the second information, the second information only reserves the text message part in the first information.

Further, the second information is a message of a message standard SIPMES SAGE in the SIP standard protocol.

In the specific conversion process, when the input first message used for instant messaging using the enterprise private protocol is a text message, a picture, a video or a file, the message of a message standard SIPMESSAGE in the SIP standard protocol only can be converted, that is, the first information cannot be input when being a picture, a video and a file, and is practically impossible to send; and otherwise, only the message (second information) of the SIPMES SAGE using the SIP standard protocol can be converted into a text message (first information) of instant messaging private to an enterprise, that is, the second information cannot be other formats (eg, a picture, video and file) except the text message, and actually it does not have the capability of sending other formats.

Wherein the first information is at least one of an audio and an audio-and-video. At the moment, the second information is the information of the RFC3261 standard in the instant messaging SIP standard protocol.

The RFC3261 is a SIP Soft Phone standard, and is a standard protocol client software, so that a terminal product matched with the system has rich and advanced functional characteristics, the interface is friendly, the configuration is simple, the usability is high, which is compatible with the latest other protocol related standards, and has good interoperability with other related protocol standard products.

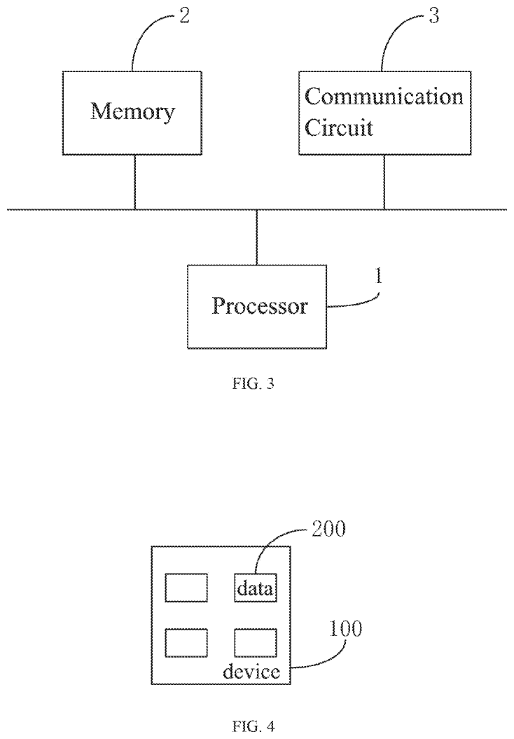

Referring to FIG. 3, FIG. 3 is a schematic structural diagram of a gateway according to an embodiment of the disclosure, the gateway includes: a processor 1, a memory 2 and a communication circuit 3, wherein the processor 1 is respectively coupled with the memory 2 and the communication circuit 3, and the processor 1, the memory 2 and the communication circuit 3 can realize the steps of any one of the methods mentioned above in the working process. For details of related content, reference can be made to the method part, and the details are not described herein. Referring to FIG. 4, FIG. 4 is a schematic structural diagram of a device with storage function according to an embodiment of the disclosure, the device 100 stores program data 200, and the steps in any one of the methods mentioned above can be achieved when the program data 200 is executed by the processor. For details of related content, reference can be made to the method part, and the details are not described herein.

It should be noted that, in the disclosure, the term “comprising”, “including” or any other variants thereof intend to encompass a non-exclusive inclusion, such that a process, a method, an article or a system comprising a series of element snot only comprises those elements but also includes other elements not explicitly listed, or further includes elements inherent to the process, the method, the article or the system.

In the case that there are no more limitations, an element defined by a statement “comprises a . . . ”, it is not excluded that additional identical elements exist in the process, the method, the article or the system comprising the element.

The above-mentioned sequence numbers of the embodiments of the disclosure are only for description, and do not reflect good or bad of the embodiments.

Through the description of the above-mentioned embodiments, those skilled in the art can clearly understand that the method can be realized by means of software and necessary universal hardware platforms. It is also possible to realize through hardware, but in many cases, the former is a better implementation manner. Based on such understanding, the technical solutions of the disclosure are essentially or the parts which make contributions to the current technology can be embodied in the form of a software product, the computer software product is stored in a storage medium (such as a ROM/RAM, a magnetic disk and an optical disk) as mentioned above, and comprises a plurality of instructions which are used for enabling a terminal device (which can be a mobile phone, a computer, a server, an air conditioner, a network device and the like) to implement the method provided by the embodiments of the disclosure.

The above is only preferred embodiments of the disclosure and is not intended to limit the patent scope of the disclosure, the equivalent structure or equivalent process modification made by using the contents of the specification and the drawings of the disclosure or embodiments directly or indirectly applied to other related technical fields are universally included in the patent protection scope of the disclosure.

1. (canceled)

2. The method according to claim 11, wherein the initial message is at least one of a text, a picture, a video and a file.

3. The method according to claim 2, wherein the first message only retains a text message part in the initial message.

4. The method according to claim 3, wherein the first message is a message of a message standard SIPMESSAGE in the SIP standard protocol.

5. The method according to claim 2, wherein the non-SIP standard initial protocol comprises: at least one of an Extensible Messaging and Presence protocol (XMPP), a Message Queuing Telemetry Transport protocol (MQTT), a Socket protocol (Socket) and an enterprise private protocol.

6. The method according to claim 11, wherein the initial message is at least one of an audio, an audio-and-video.

7. The method according to claim 6, wherein the first message is information of a RFC3261 standard in the SIP standard protocol.

8. The method according to claim 6, wherein the non-SIP standard protocol comprises: at least one of a H323 protocol and an enterprise private protocol.

9. A gateway, comprising a processor, a memory and a communication circuit, wherein the processor is respectively coupled with the memory and the communication circuit, when the processor, the memory and the communication circuit are in operation, following operations are realized:
receiving, from a first instant messaging client, an initial message formed with a first instant messaging non-SIP standard protocol;
converting the initial message into a first message with a SIP standard protocol;
converting the first message formed with the SIP standard protocol into a second message formed with a second instant messaging non-SIP standard protocol, wherein the second instant messaging non-SIP standard protocol is different from the first instant messaging non-SIP standard protocol; and
outputting the second message to a second instant messaging client, to implement communication between the first and the second instant messaging clients.

10. A device with storage function, wherein program data is stored on the device, wherein when the program data is executed by the processor, following operations are realized:
receiving, from a first instant messaging client, an initial message formed with a first instant messaging non-SIP standard protocol;
converting the initial message into a first message with a SIP standard protocol;
converting the first message formed with the SIP standard protocol into a second message formed with a second instant messaging non-SIP standard protocol, wherein the second instant messaging non-SIP standard protocol is different from the first instant messaging non-SIP standard protocol; and
outputting the second message to a second instant messaging client, to implement communication between the first and the second instant messaging clients.

11. A method for converting information comprising:
receiving, from a first instant messaging client, an initial message formed with a first instant messaging non-SIP standard protocol;
converting the initial message into a first message with a SIP standard protocol;
converting the first message formed with the SIP standard protocol into a second message formed with a second instant messaging non-SIP standard protocol, wherein the second instant messaging non-SIP standard protocol is different from the first instant messaging non-SIP standard protocol; and
outputting the second message to a second instant messaging client, to implement communication between the first and the second instant messaging clients.
